(19) United States
(12) Patent Application Publication
(10) Pub. No.: US 2005/0284978 A1
(43) Pub. Date: Dec. 29, 2005

(54) Dual level load limiting belt retractor with mechanical load switching

(76) Inventor: Jeffry N. Zolkower, West Bloomfield, MI (US)

Correspondence Address: DELPHI TECHNOLOGIES, INC., M/C 480-410-202, PO BOX 5052, TROY, MI, 48007, US

(21) Appl. No.: 10/880,139

(22) Filed: Jun. 29, 2004

(51) Int. Cl. B60R 22/28; B60R 22/36

(52) U.S. Cl. 242/382.4; 242/379.1

(57) ABSTRACT

A seat belt restraint system includes a dual level load limiting belt retractor that has a high level load limit and a low level load limit resisting paying-out the belt when the belt retractor is locked. The belt retractor includes a mechanical load switch mechanism that is responsive to the length of belt that is payed out of the belt retractor to switch from a low level load limit to a high level load limit.

### FIELD OF THE INVENTION

This invention relates to a belt retractor and more particularly to a dual level load limiting belt retractor.

### BACKGROUND OF THE INVENTION

U.S. Pat. No. 6,648,260 B2 granted to James Lloyd Webber et al Nov. 18, 2003, discloses a dual level load limiting belt retractor in a seat belt restraint system. The retractor has two distinct load limit levels, high and low, that are achieved by the selecting a load path through one of two torsion bars. The load path is changed from a high load limit level to a low load limit level by detonation of a pyrotechnic charge that is actuated by a controller. With data available from several sensors, the controller provides an appropriate belt load for small and large seat occupants under various conditions.

A drawback of the belt retractor is the significant cost of controller, sensors, wiring, electrical connectors and pyrotechnic device and their assembly into the overall system.

An important factor in the selection of an appropriate load limit level for a belt retractor in a seat belt restraint system is occupant size. Occupant size is a particularly important factor for the selection of an appropriate load limit level in a rear seat application where there is no airbag with the seat belt being required to absorb all of the energy of the seat occupant in a head-on collision.

### SUMMARY OF THE INVENTION

This invention provides an alternative to the expensive system described in the Webber et al '260 patent by approximating the size of a seat occupant by the length of belt that is extracted from the belt retractor to secure the occupant in the seat. A larger occupant requires a longer length of belt to be extracted from the retractor than a smaller occupant. The belt retractor senses the length of belt extracted to secure a seat occupant and then uses this information to approximate the size of the seat occupant and select the appropriate load limit level for that seat occupant. The belt retractor is particularly useful in a rear seat application where seat adjustment is typically not a factor and where weight sensors are typically not provided.

The invention provides a dual level load limiting belt retractor that by a pure mechanical means selects one of two load limit levels based on the length of belt that is extracted from the belt retractor. This belt retractor has the benefits of significant assembly and system cost reduction as compared to the prior art dual level load limiting belt retractors. The belt retractor does not require a pyrotechnic device to switch from a high load limit level to a low load limit level as in the prior art device. The belt retractor does not require seat occupant weight sensing, nor an electronic control module, nor any wiring and connectors. The belt retractor can be applied in rear seat applications without any need for other control equipment.

### BRIEF DESCRIPTION OF THE DRAWINGS

FIG. 1 is a perspective view of a dual level load limiting belt retractor of the invention illustrated in operational relationship with a seat belt restraint system of a vehicle.

FIG. 2 is an exploded perspective view of the dual level load limiting belt retractor of FIG. 1.

FIG. 3 is a partial front view of selected components of the dual level load limiting belt retractor of FIG. 1 taken substantially along the line 3-3 of FIG. 2 looking in the direction of the arrows. The belt retractor is shown with the belt fully retracted.

FIG. 4 is a partial rear view of other selected components of the dual level load limiting belt retractor of FIG. 1 taken substantially along the line 4-4 of FIG. 2 looking in the direction of the arrows. The belt retractor is shown with the belt fully retracted.

FIG. 5 is a partial rear view of the other selected components of the dual level load limiting belt retractor of FIG. 2 shown with the belt payed out for a small seat occupant.

FIG. 6 is a partial rear view of the other selected components of the dual level load limiting belt retractor of FIG. 2 shown with the belt payed out for a large seat occupant.

FIG. 7 is a partially sectioned, perspective side view of the dual level load limiting belt retractor of FIG. 1.

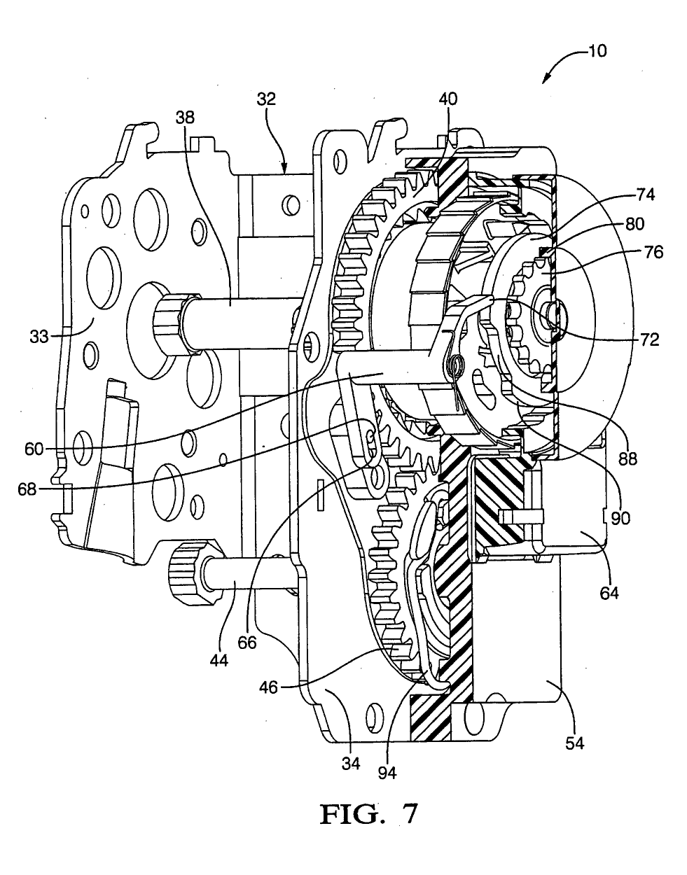

FIG. 8 is a front perspective view of a few components of the dual level load limiting belt retractor of FIG. 1.

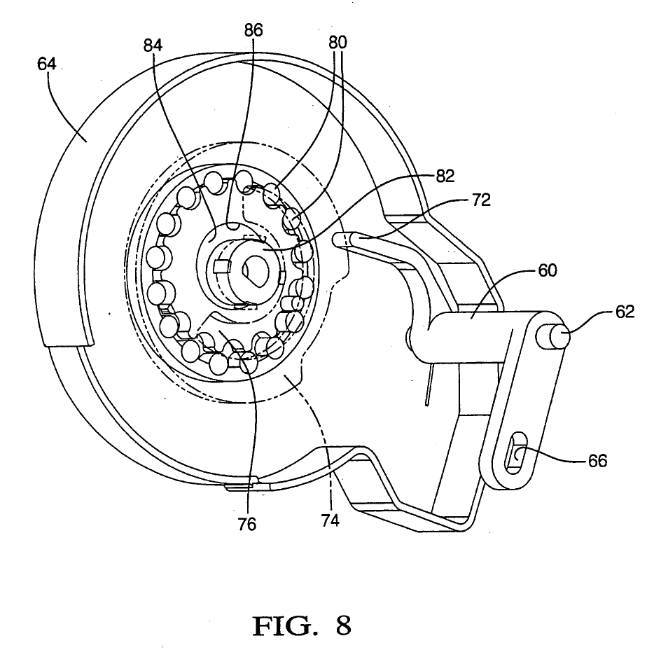

### DETAILED DESCRIPTION OF PREFERRED EMBODIMENT

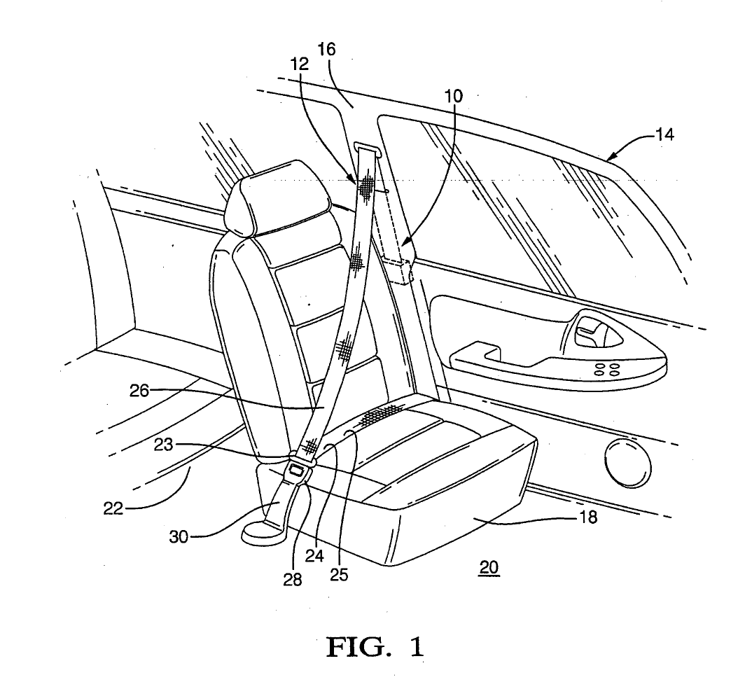

Referring to the drawings and in particular to FIG. 1, one embodiment of a dual level load limiting belt retractor 10, according to the present invention, is shown in operational relationship with a seat belt restraint system, generally indicated at 12, in a vehicle (partially shown), generally indicated at 14. The vehicle 14 includes a vehicle body 16 and a seat 18 mounted by suitable means to vehicle structure 20 such as a floorpan in an occupant compartment 22 of the vehicle body 16. The seat 18 is illustrated as a front seat of the vehicle 14. However, seat 18 could be a rear, a second row, or a third row seat in the vehicle 14.

Seat belt restraint system 12 restrains an occupant (not shown) in seat 18. The seat belt restraint system 12, which is known as a three point system, includes a latch tongue or plate 23 that slides on a belt 24 dividing the belt 24 into a lap belt 25 and a shoulder belt 26. One end of belt 24 (usually the free end of lap belt 25) is anchored to vehicle structure 20. The other end of belt 24 (usually the free end of shoulder belt 26) is connected to the dual level load limiting belt retractor 10. The seat belt restraint system 12 also includes a buckle assembly 28 connected by suitable means such as belt webbing 30 to the vehicle structure 20. Latch plate 23 is engageable and disengageable with the buckle assembly 28. Except for the dual level load limiting belt retractor 10 of the invention, the seat belt restraint system 12 is conventional and known in the art.

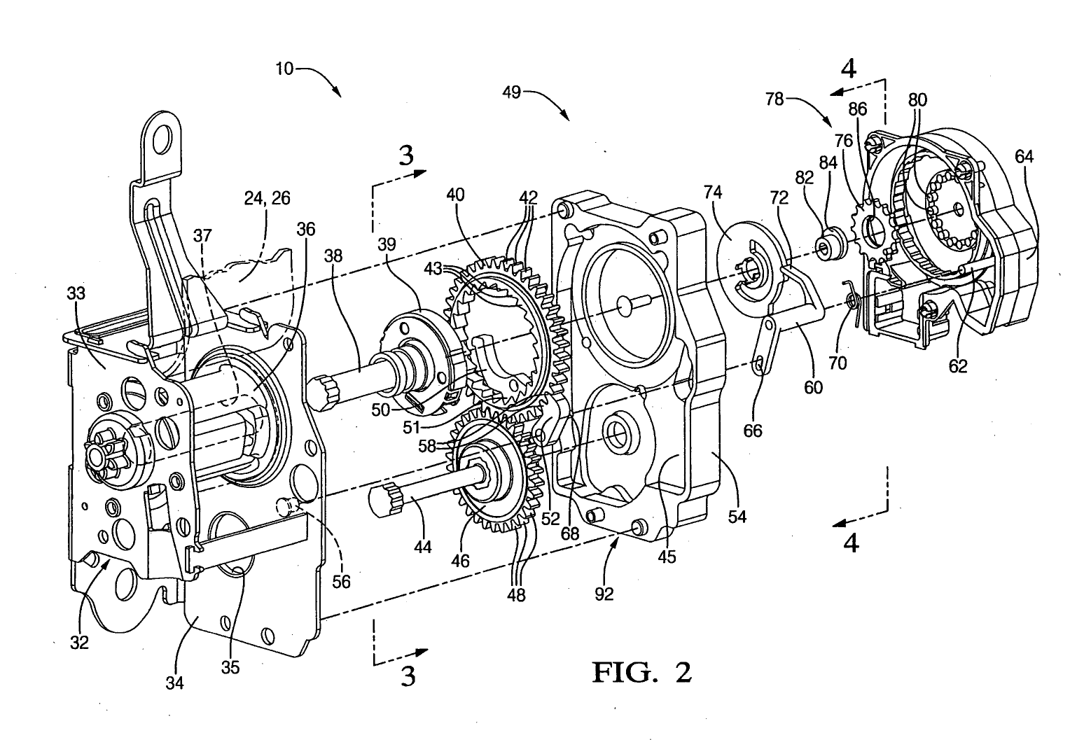

Referring now to FIG. 2, the dual level load limiting belt retractor 10 includes a housing 32 having spaced apart sidewalls 33 and 34 and a belt reel or take-up spool 36 disposed between the sidewalls 33 and 34. Belt 24, shown in phantom, is connected to spool 36 by suitable means such as a slot (not shown) in the take-up spool 36 and a bar (not shown) through a loop (not shown) at the free end of the shoulder belt 26 cooperating with the slot. The dual level load limiting belt retractor 10 includes a first, high level torsion bar 38 extending through a passageway 37 of the take-up spool 36. The first, high level torsion bar 38 has one end rotatably mounted in an aperture of sidewall 33 and an opposite end connected to a locking bobbin 39 that is rotatably mounted directly or indirectly in an aperture of sidewall 34 such that the first, high level torsion bar 38, locking bobbin 39, and take-up spool 36 are rotatable relative to the housing 32.

The first, high level torsion bar 38 has one end fixed to the take-up spool 36 and an opposite end fixed to the locking bobbin 39 and is a constant force limiting member that deforms inside the take-up spool 36 to absorb energy as explained below. The first, high level torsion bar 38 serves as a means to provide a high level of load limiting, such as for example approximately four kilonewtons (4 kN) to approximately six kilonewtons (6 kN), for resisting extracting or paying-out belt 24 from spool 36 when belt retractor 10 is locked. Housing 32 is attached by suitable means (not shown) to either the vehicle body 16 or the seat 18. The free end of shoulder belt 26 is connected to and wrapped around the take-up spool 36 to take up slack in belt 24.

The dual level load limiting belt retractor 10 also includes a retractor spring (not shown) disposed about one end of the spool 36 or first torsion bar 38. The retractor spring is of a spiral type having one end attached to the first torsion bar 38 and an opposite end connected to the housing 32 as known in the art. The retractor spring may be enclosed by a spring housing (not shown) attached to the sidewall 33 of the housing 32. The retractor spring has a predetermined torque or tension and urges the first torsion bar 38, locking bobbin 39, and take-up spool 36 in a predetermined direction (counterclockwise, as shown in FIG. 2) to wind the shoulder belt 26 up onto the take-up spool 36. The retractor spring is conventional and known in the art.

The locking bobbin 39 is rigidly or fixedly attached to and disposed about the end of the first torsion bar 38. The bobbin 39 is generally cylindrical in shape with a generally circular cross-sectional shape and is preferably made of a metal material such as aluminum. Bobbin 39 is concentrically attached and secured to the take-up spool 36 by suitable means such as staking or press-fitting.

The dual level load limiting belt retractor 10 also includes a first, high-level gear 40 disposed about one end of the bobbin 39 outside of the sidewall 34 of housing 32. The first gear 40 is generally circular in shape and has a plurality of external circumferentially spaced teeth 42. The first gear 40 also has a plurality of internal, circumferentially spaced ratchet teeth 43. Locking bobbin 39 and the end of the first torsion bar 38 to which the locking bobbin 39 is attached rotate together as a unit. Locking bobbin 39 may rotate freely with respect to the first gear 40.

The dual level limiting belt retractor 10 includes a second, low level torsion bar 44 having one end fixed to sidewall 33 of the housing 32 and an opposite end extending through an aperture 35 of sidewall 34. The axis of the second low level torsion bar 44 is parallel to and spaced laterally from the axis of the first, high level torsion bar 38. The second low level torsion bar 44 serves as a means to provide a low level of load limiting, such as for example approximately two kilonewtons (2 kN) to approximately three kilonewtons (3 kN), for resisting extracting or paying-out belt 24 from spool 36 when belt retractor 10 is locked. The one end of the second torsion bar 44 is fixed to the housing 32 by any suitable means.

The dual level load limiting belt retractor 10 further includes a second, low-level gear 46 rigidly or fixedly attached to and disposed about the other end of the second torsion bar 44 via a hub 47. The second gear 46 is disposed outside of the sidewall 34 of housing 32 on the same side as the first gear 40. The second gear 46 is generally circular in shape and has a plurality of external circumferentially spaced teeth 48 that mesh with the external teeth 42 of first gear 40. Second gear 46 is secured onto the second torsion bar 44 by suitable means such as staking or press-fitting. Second gear 46 and the end of the second torsion bar 44 to which second gear 46 is attached, rotate together as a unit.

First gear 40 and second gear 46 are disposed in a chamber 45 of a side plate 54 that is attached to side wall 34.

The dual level load limiting belt retractor 10 includes a mechanical switch mechanism, generally indicated at 49, cooperating with the first gear 40 and the second gear 46 for switching operation from a first high level of load limiting to a second low level of load limiting. Switch mechanism 49 includes a lock 50 moveably connected to bobbin 39. Lock 50 has at least one but, preferably a plurality of teeth 51 spaced circumferentially for engagement with the internal ratchet teeth 43 of the first gear 40 as best shown in FIG. 2. The lock 50 and bobbin 39 rotate together as a unit with the lock 50 usually held away from the teeth 43 of the first gear 40 by suitable means such as a spring (not shown).

The mechanical switch mechanism 49 includes a lock arm 52 that is disposed in chamber 45 and that is pivotally attached to the side plate 54 of housing 32 by a pivot pin 56. Lock arm 52 has at least one but may have a pair of projections 58 that engage the external teeth 42 of the first gear 40. First gear 40 acts as a detent member when the lock arm 52 is engaged with gear 40.

The dual level load limiting belt retractor 10 also includes a cam follower lever 60 that pivots on a pivot pin 62 of a side cover 64 that is attached to the side plate 54. Cam follower lever 60 has a slot 66 at the lower end that receives an integral pin 68 of lock arm 52. A torsion spring 70 located on pivot pin 62 biases the cam follower lever 60 counter clockwise as viewed in FIG. 2 so that the nose 72 at the upper end of cam follower lever 60 engages a rotary cam 74.

Rotary cam 74 is attached to an external gear 76 of a gerotor mechanism 78. External gear 76 meshes with an internal gear 80 that is an integral part of side cover 64. Gerotor mechanism 78 further comprises a rotor 82 that has an eccentric, circular drive portion 84 that engages a circular bore 86 of external gear 76. Rotor 82 is drivingly connected to locking bobbin 39. The gerotor mechanism 78 operates in a well known manner so that when locking bobbin 39 is driven clockwise (as viewed in FIG. 2) by the belt 24 being pulled off of drum spool 36, rotor 82 is also driven clockwise while external gear 76 is driven counterclockwise. External gear 76 is driven clockwise at a greatly reduced speed, typically at a ratio of 12 to 1 or displaced in the counterclockwise direction a greatly reduced amount, it typically taking 12 clockwise revolutions of the drum spool 36 to rotate cam 74 one full revolution in the counterclockwise direction.

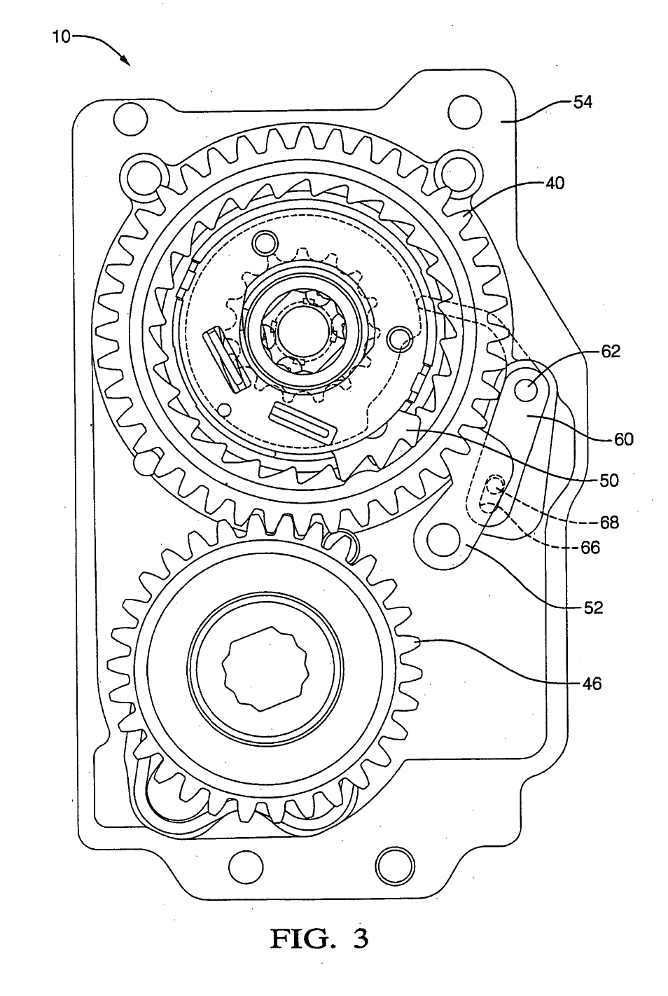

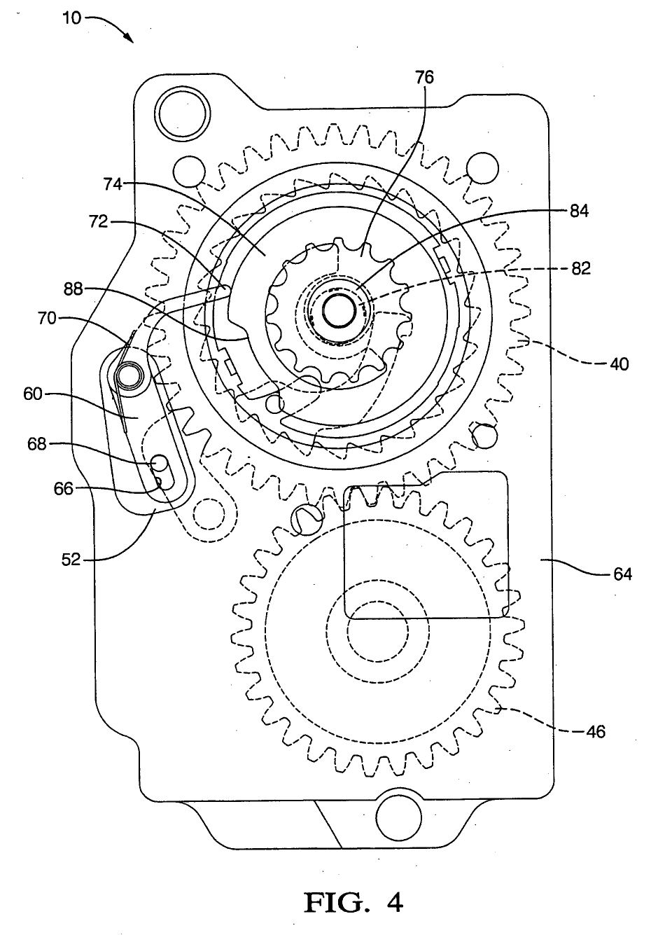

The mechanical switch mechanism 49 operates responsive to the length of belt 24 that is extracted from belt retractor 10 as follows. With the belt 24 fully retracted, the parts are in the position shown in FIGS. 3 and 4 of the drawings except for lock 50. The operation of lock 50 is well known and need not be described in detail. Basically, lock 50 is normally disengaged from ratchet teeth 43 so that spool 36 is rotated relative to gear 40 as the belt 24 is payed out. As the belt 24 is pulled or payed off the spool 36, the spool 36 rotates in the counterclockwise direction which indexes cam 74 in the clockwise direction. Initially the high level torsion bar 38 is operative so that upon locking of the spool 36 by lock 50 in a well known manner, any rotation of spool 36 is resisted by twisting of the high level torsion bar 38. This high load level preferably prevails for enough belt to be pulled off spool 36 to strap a child seat (not shown) securely in a rear seat (not shown).

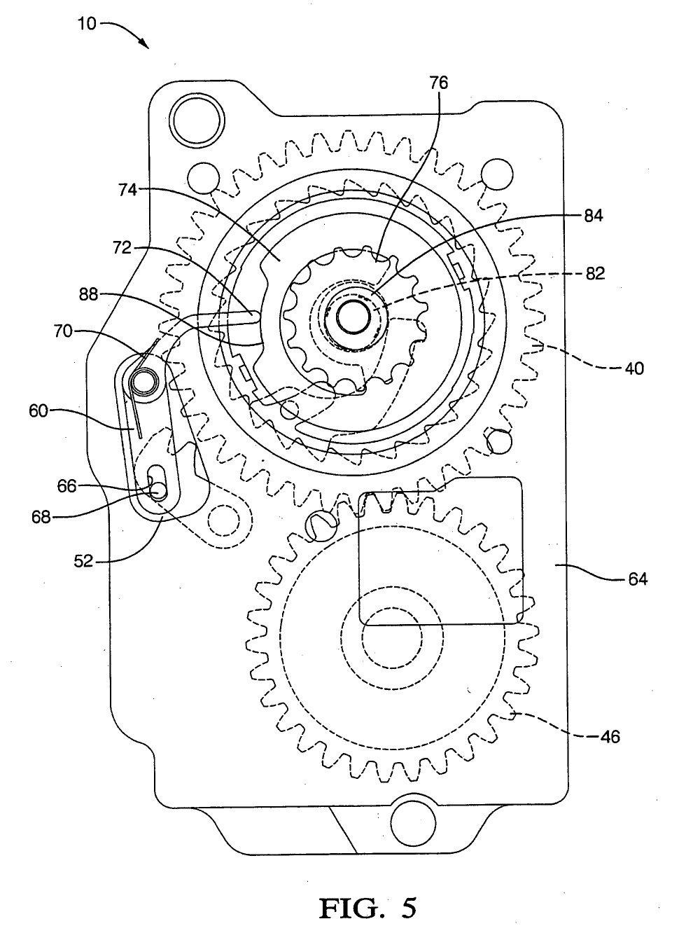

When the length of belt 24 that is pulled off spool 36 corresponding to a smaller occupant of predetermined size, the spool 36 is rotated a predetermined number of revolutions in the counterclockwise direction while cam 74 is indexed in the clockwise direction to the position shown in FIG. 5 of the patent drawing. In the position of FIG. 5, the nose 72 of the cam follower lever 60 engages in notch 88. As a result cam follower lever 60 pivots clockwise which in turn pivots lock arm 52 counterclockwise and disengages lock arm 52 from high level gear 40. This condition is indicative of a small seat occupant. Due to the disengagement of the lock arm 52, the low level torsion bar 44 is operative so that upon locking of the spool 36 by lock 50, any further rotation of spool 36 is resisted by twisting of the low level torsion bar 44 via meshing gears 40 and 46.

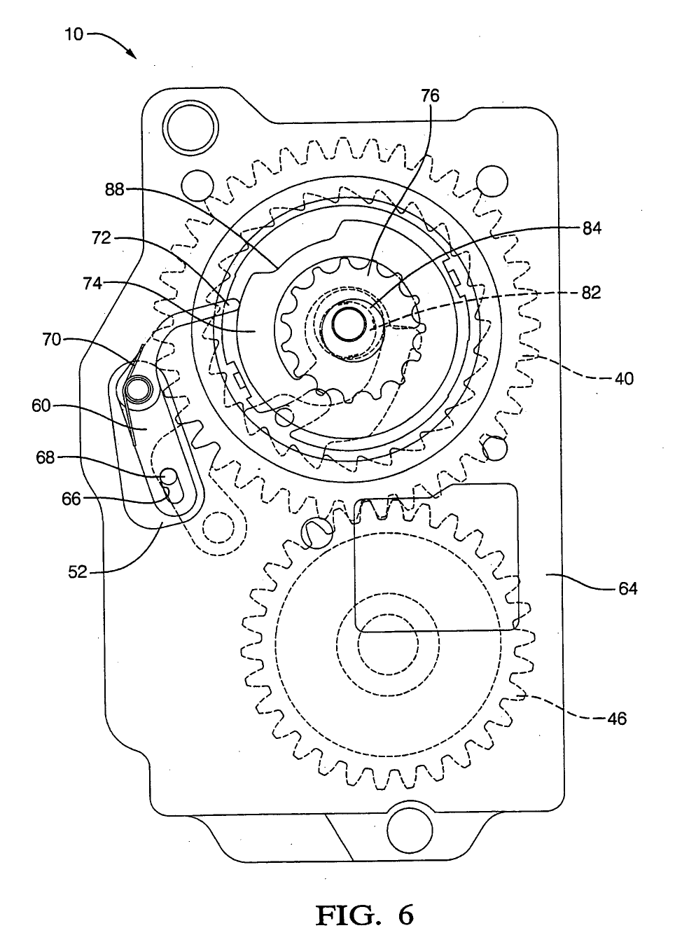

If the seat occupant is larger, then a greater length of belt 24 is pulled off of the spool 36 and the cam 74 is indexed in the clockwise direction a greater amount so that the nose 72 of the cam follower lever 60 rides up out of the notch 88 and onto the outer diameter surface 90 of the cam 74 as shown in FIG. 6 of the patent drawing. This causes cam follower lever 60 to rotate in the counterclockwise direction which in turn rotates the lock arm 52 in clockwise direction and into engagement with the high level gear 40. The high level torsion bar 38 is now operative so that any belt payout after the belt retractor 10 is locked by lock 50, is resisted by the twisting of the high level torsion bar 38.

When belt 24 is released, it is automatically rewound on spool 36 by the return spring (not shown) which causes the spool 36 to rotate clockwise and the cam 74 to index in the counterclockwise direction back to the staring position shown in FIGS. 3 and 4.

Thus it can be seen that the belt retractor of the invention is a dual level, load limiting retractor that by a pure mechanical means provides one of two load limit levels that are selected based on the length of belt extracted from the belt retractor. The belt retractor has benefits of significant assembly and system cost reduction as compared to the prior art dual lever load limiting retractors. The retractor assembly does not require a pyrotechnic charge to be used for switching as in the prior art device. Further the retractor does not require occupant weight sensing, input and outputs from an electric central module to sensors and the belt retractor, and the corresponding wiring and connectors. The belt retractor is well suited for rear seat applications where the cost of applying sensor and wiring is considered prohibitive.

While a particular type of mechanical switch mechanism 49 has been disclosed, any type of mechanical switch mechanism that is responsive to the length of belt that is pulled or payed off the spool 36 can be used. For instance, a spur gear or planetary gear arrangement can be used instead of the gerator mechanism 78 to provide a speed reduction from spool 36 to cam 74.

In other words, many modifications and variations of the present invention are possible in light of the above teachings. Therefore, within the scope of the appended claims, the present invention may be practiced other than as specifically described.

1. A dual level load limiting belt retractor comprising:
a housing having a rotatable take-up spool connected to a belt for winding the belt onto the take-up spool and paying-out the belt from the take-up spool,
a lock for locking the take-up spool against rotation in a pay-out direction,
a first torsion bar operatively connected to the housing at one end and to the take-up spool at the other end to provide a high level load limit for resisting paying-out the belt when the take-up spool is locked;
a second torsion bar operatively connected to the housing at one end and to the take-up spool at the other end to provide a low level load limit for resisting paying-out the belt when the take-up spool is locked, said low level load limit being less than the high level load limit; and
a mechanical switch mechanism operatively cooperating with the first torsion bar and the second torsion bar to switch from one level load limit to another level load limit responsive to the length of belt that is payed out of the belt retractor.

2. The dual level load limiting retractor as defined in claim 1 wherein the mechanical switch mechanism switches from the high level load limit to the low level load limit responsive to the length of belt that is payed out of the belt retractor.

3. The dual level load limiting retractor as defined in claim 1 wherein the mechanical switch mechanism switches from the high level load limit to the low level load limit responsive back to the high level load limit responsive to the length of belt that is payed out of the belt retractor.

4. The dual level load limiting retractor as defined in claim 1 wherein the mechanical switch mechanism switches from the low level load limit to the high level load limit responsive to the length of belt that is payed out of the belt retractor.

5. The dual level load limiting belt retractor as defined in claim 1 further including a gear train comprising a high load level gear that is driven by the take-up spool when the take-up spool is locked and a low load level gear that is connected to the other end of the second torsion bar for rotation therewith and wherein the mechanical switch mechanism comprises a lock arm that is pivotally attached to a support and that has at least one projection that engages external teeth of the high load level gear to provide a high level limit operation.

6. The dual level load limiting belt retractor as defined in claim 5 wherein the switch mechanism includes a cam that is rotated responsive to the length of belt that is paid out of the belt retractor and a cam follower lever that operates the lock arm to engage or disengage the external teeth of the high load lever gear.

7. The dual level load limiting belt retractor as defined in claim 6 wherein the cam follower lever has a slot at a lower end that receives an integral pin of the lock arm.

8. The dual level load limiting belt retractor as defined in claim 7 wherein the cam follower lever is biased into engagement with the cam.

9. The dual level load limiting belt retractor as defined in claim 8 wherein the rotary cam is driven by the spool via a gerotor mechanism.

10. The dual level load limiting belt retractor as defined in claim 9 wherein the gerotor mechanism comprises an external gear that meshes with an internal gear that is an integral part of a side cover.

11. The dual level load limiting belt retractor as defined in claim 10 wherein the gerotor mechanism comprises a rotor that has an eccentric, circular drive portion that engages a circular bore of the external gear and wherein the rotor is drivingly connected to the take-up spool via a locking bobbin.

12. A dual level load limiting belt retractor comprising:
a housing having a rotatable take-up spool connected to a belt for winding the belt onto the take-up spool and paying-out the belt from the take-up spool,
a lock for locking the take-up spool against rotation in a pay-out direction,
a first torsion bar operatively connected to the housing at one end and to the take-up spool at the other end to provide a high level load limit for resisting paying-out the belt when the take-up spool is locked;
a second torsion bar operatively connected to the housing at one end and to the take-up spool at the other end to provide a low level load limit for resisting paying-out the belt when the take-up spool is locked, said low level load limit being less than the high level load limit; and
a mechanical switch mechanism operatively cooperating with the first torsion bar and the second torsion bar to switch from the high level load limit to the low level load limit responsive to the length of belt that is payed out of the belt retractor,
the mechanical switch mechanism including a cam that is driven by the take-up spool and a cam follower lever that moves the lock back and forth between a locked position and a release postion responsive to the angular position of the cam, the lock locking the take-up spool against rotation in the pay-out direction in the locked position, and allowing rotation of the take-up spool in the pay-out direction in the release position.

13. The dual level load limiting belt retractor as defined in claim 12 wherein the rotary cam is driven by the spool via a gerotor mechanism comprising an external gear that meshes with an internal gear that is an integral part of a side cover and a rotor that has an eccentric, circular drive portion that engages a circular bore of the external gear and wherein the rotor is drivingly connected to the take-up spool via a locking bobbin.

14. A dual level load limiting belt retractor comprising:
a housing having a rotatable take-up spool connected to a belt for winding the belt onto the take-up spool and paying-out the belt from the take-up spool,
a lock for locking the take-up spool against rotation in a pay-out direction,
first means to provide a high level load limit for resisting paying-out the belt when the take-up spool is locked;
second means to provide a low level load limit for resisting paying-out the belt when the take-up spool is locked, said low level load limit being less than the high level load limit; and
a mechanical switch mechanism operatively cooperating with the first means and the second means to switch from the low level load limit to the high level load limit responsive to the length of belt that is payed off of the spool.

15. The dual lever load limiting belt retractor as defined in claim 14 wherein the mechanical switch mechanism includes a cam, a cam follower lever that moves the lock responsive to the position of the cam and a gerotor mechanism for indexing the cam responsive to the rotation of the spool and the length of belt that is payed off of the spool.
